(19) United States
(12) Patent Application Publication
(10) Pub. No.: US 2025/0067332 A1
(43) Pub. Date: Feb. 27, 2025

(54) Linear and Higher-Order Interpolating Gear Trains and Gear Networks

(71) Applicant: Udayan Kanade, Pune (IN)

(72) Inventor: Udayan Kanade, Pune (IN)

(73) Assignee: Udayan Kanade, Pune, MH (IN)

(21) Appl. No.: 18/915,329

(22) Filed: Oct. 14, 2024

Related U.S. Application Data
(63) Continuation-in-part of application No. 17/293,091, filed on May 12, 2021, now Pat. No. 12,146,550.

(51) Int. Cl. F16H 57/033; G06F 17/12

(52) U.S. Cl. CPC F16H 57/033; G06F 17/12

(57) ABSTRACT

Ways of creating polynomial interpolations in one, two and three dimensions using mechanical means. Arrangements of gears can constrain rotating elements to rotate equal to the average or difference of the rotation angles of other rotating elements. These arrangements are combined to create mechanical arrangements having a set of rotating elements that are constrained to be linear or polynomial functions in one or many dimensions. Specifically, a train of gears is mechanically constrained to always rotate in such a manner that the rotations of successive gears in the gear train form a polynomial function of a defined order, and then controlled using electronic devices to attain various specific polynomial functions of that order. Multiple trains of gears are constrained in a similar manner to create interpolations in two and three dimensions. Mechanical polynomial interpolation for focusing sun rays for energy production and other utilities, including manufacturing objects using shape-changing molds.

This patent is a continuation-in-part of patent application Ser. No. 17/293,091 filed in the USPTO on Dec. 5, 2021, which in turn claims priority from provisional patent application No. 20/182,1042950 titled “INTERPOLATING GEAR TRAIN” filed in Mumbai, India on 15 Nov. 2018

### TECHNICAL FIELD

This invention relates to machines. More specifically it relates to sets of gears which actuate an interpolated function.

### BACKGROUND ART

Gears which mesh with other gears are well known in the art. Gears are usually used to modify the speed and torque of circular motion transmitted from a drive to a machine that uses that circular motion. A specific type of gear system, known as ‘differential gears’ is also known in the art. Differential gears are used to drive more than one wheels using a single drive, where the wheels may be naturally connected in a way that makes them turn in a ratio with respect to each other. For example, the two wheels of a vehicle that is turning are turning at different speeds, the ratio of the speeds dependent on the radius of the turn; but both these wheels may be driven by a single drive if a differential gear box is used. A similar mechanical arrangement is used for the reverse application as well: a single machine being driven by two or more drives, as may be used in vehicles with hybrid power sources.

Heliostats are well known in the art. Heliostats are mirrors that individually reflect sunlight onto a target. As the position of the sun changes in the sky, the heliostats change their orientation to keep reflecting sunlight onto the target. Each heliostat is controlled by electronic drives.

### SUMMARY OF INVENTION

Various ways of creating polynomial interpolations in one, two and three dimensions using purely mechanical means are disclosed. Various arrangements of gears are disclosed that can constrain certain rotating elements to rotate equal to the average or difference of the rotation angles of other rotating elements. These arrangements are combined in various ways to create mechanical arrangements having a set of rotating elements that are constrained to be linear or polynomial functions in one or many dimensions. More specifically, a train of gears is mechanically constrained to always rotate in such a manner that the rotations of successive gears in the gear train form a polynomial function of a defined order, and then controlled using electronic devices to attain various specific polynomial functions of that order. Multiple such trains of gears are constrained in a similar manner to create interpolations in two and three dimensions. Various uses of mechanical polynomial interpolation are disclosed, including focusing rays of the sun onto a target for energy production and other utilities, as well as including manufacturing objects using shape-changing molds.

In an embodiment of the invention, a system of interpolating gear network is disclosed. The system comprising of a plurality of gearboxes arranged sequentially in a plurality of rows, wherein the plurality of rows includes a first row and a second row, having each of the gearboxes in second row comprising at least a first rotary element, a second rotary element and a third rotary element, wherein the second rotary element is constrained to rotate by an amount equal to a linear combination of the rotations of the first rotary element and the third rotary element, wherein the first rotary element of each of the gearboxes in second row except the first gearbox in second row are connected to the third rotary element of the preceding gearbox in second row, wherein the second rotary elements of the plurality of gearboxes in second row are connected to the plurality of gearboxes in first row, wherein the second row of plurality of gearboxes produces a quadratic function and the first row of plurality of gearboxes produces a linear function.

In an embodiment of the invention, the first row comprises sequentially arranged plurality of gearboxes, wherein each of the plurality of gearboxes in first row comprises at least a first rotary element, a second rotary element and a third rotary element, wherein the second rotary element is constrained to rotate by an amount equal to a linear combination of the rotations of the first rotary element and the third rotary element. The second rotary element of each of the plurality of gearboxes in first row are connected to the third rotary element of preceding gearbox in first row if the preceding gearbox exists, and to the first rotary element of succeeding gearbox in first row if the succeeding gearbox exists. The first rotary element of each of the gearboxes in first row except for the first gearbox in the first row are connected to the third rotary element of preceding gearbox in first row, and wherein the second rotary elements of all gearboxes in first row are connected to each other so as to rotate together.

In another embodiment of the invention, the system further comprising one or more third rows of sequentially arranged gearboxes in third row, wherein each of the gearboxes in third row comprises at least a first rotary element, a second rotary element and a third rotary element, wherein the second rotary element is constrained to rotate by an amount equal to a linear combination of the rotations of the first rotary element and the third rotary element, wherein the first rotary element of each of the gearboxes in third row except the first gearbox in third row are connected to the third rotary element of the preceding gearbox in the same third row, and wherein the second rotary element of a gearbox in third row is connected to rotary elements of gearboxes on a preceding row or to rotary elements of gearboxes in second row.

In another embodiment of the invention, the plurality of gearboxes are connected in a 2D array interpolation gear network arranged in a sequence selected from linear order interpolation, bi-linear order interpolation or polynomial order interpolation. The system further comprising electronic drives connected to some of the rotary elements of some of the gearboxes, the electronic drives configured to drive the system so as to create a required polynomial function. The system further comprising mirrors. The plurality of gearboxes are planetary gears and at least two other gears. The planetary gears are selected from beveled gears and face gears.

The above and other preferred features, including various details of implementation and combination of elements are more particularly described with reference to the accompanying drawings and pointed out in the claims. It will be understood that the particular methods and systems described herein are shown by way of illustration only and not as limitations. As will be understood by those skilled in the art, the principles and features described herein may be employed in various and numerous embodiments without departing from the scope of the invention.

### BRIEF DESCRIPTION OF DRAWINGS

The accompanying drawings, which are included as part of the present specification, illustrate the presently preferred embodiment and together with the general description given above and the detailed description of the preferred embodiment given below serve to explain and teach the principles of the present invention.

FIG. 1A depicts an arrangement of gears according to an embodiment.

FIG. 1B depicts an arrangement of gears according to an embodiment.

FIG. 1C depicts an arrangement of gears according to an embodiment.

FIG. 2 depicts an arrangement of many gears arranged in a particular fashion.

FIG. 3 depicts a linear relation between angle variables according to an embodiment.

FIG. 4A depicts a mechanical arrangement of gear boxes in a schematic fashion.

FIG. 4B depicts gearbox i in schematic fashion.

FIG. 4C depicts an interpolating gear train according to an embodiment.

FIG. 4D depicts a gearbox according to an embodiment.

FIG. 4E depicts gearbox i in schematic fashion.

FIG. 4F depicts an interpolating gear train 492 according to an embodiment.

FIG. 4G depicts an interpolating gear train 492 according to an embodiment.

FIG. 5A depicts a gearbox with concentric axles according to an embodiment.

FIG. 5B depicts a gearbox with concentric axles according to an embodiment.

FIG. 5C depicts a gearbox according to an embodiment.

FIG. 5D depicts a gearbox with concentric axles according to an embodiment.

FIG. 5E depicts a gearbox with concentric axles according to an embodiment.

FIG. 6A depicts an interpolating gear train according to an embodiment.

FIG. 6B depicts an interpolating gear train according to an embodiment.

FIG. 7 depicts an interpolating gear train using beveled gears in a tight configuration, according to an embodiment.

FIG. 8 depicts an interpolating gear train using non-beveled gears in a tight configuration, according to an embodiment.

FIG. 9 depicts an output gear.

FIG. 10 depicts a differential gearbox in schematic form, according to an embodiment.

FIG. 11 depicts a network of differential gearboxes in schematic form, according to an embodiment.

FIG. 12 depicts a mechanical apparatus that performs as a differential gearbox according to an embodiment.

FIG. 13A depicts a gearbox as viewed from outside, according to an embodiment.

FIG. 13B depicts a mechanical arrangement made out of gearboxes according to an embodiment.

FIG. 14A depicts one row of an interpolating gear network according to an embodiment.

FIG. 14B depicts a compact interpolating gear network according to an embodiment.

FIG. 15A depicts a 2D array bi-linear interpolation gear network as a schematic, according to an embodiment.

FIG. 15B depicts a 2D array interpolation gear network as a schematic, according to an embodiment.

FIG. 16 depicts an element control mechanism according to an embodiment.

FIG. 17 depicts an element control mechanism according to an embodiment.

### DESCRIPTION OF EMBODIMENTS

Various ways of creating polynomial interpolations in one, two and three dimensions using purely mechanical means are disclosed. Various arrangements of gears are disclosed that can constrain certain rotating elements to rotate equal to the average or difference of the rotation angles of other rotating elements. These arrangements are combined in various ways to create mechanical arrangements having a set of rotating elements that are constrained to be linear or polynomial functions in one or many dimensions. Various uses of mechanical polynomial interpolation are disclosed, including focusing rays of the sun onto a target.

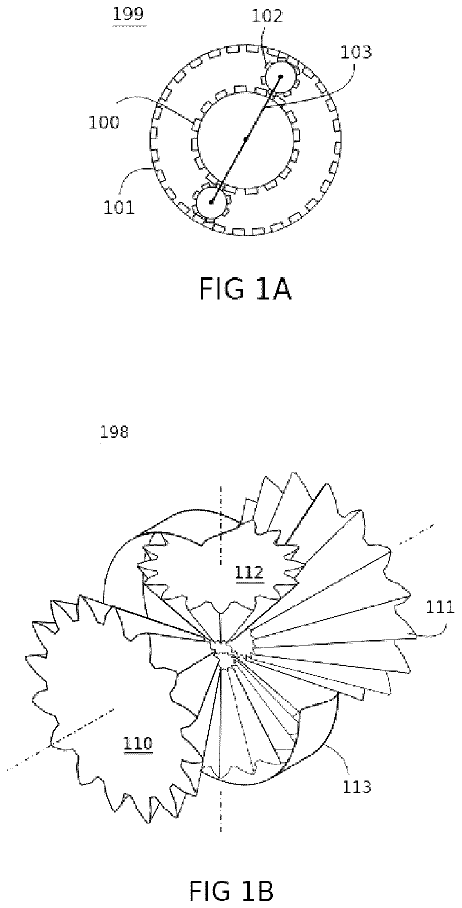

FIG. 1A depicts an arrangement 199 of gears according to an embodiment. Arrangements similar to the arrangement 199 may be variously called “epicyclic gears”, “planetary gears”, “differential gears” or “integral gears” in the art. A sun gear 100 meshes with planet gears 102 which in turn mesh with a ring gear 101. The planet gears 102 are supported by a carrier frame 103 which is a rigid frame rotating around the same axis as the common axis of sun gear 100 and ring gear 101. The carrier frame 103 is depicted as a rod, but may be any rigid body to which the axes of the planet gears 102 are attached. The arrangement 199 may have less or more than two planet gears 102, for example a single gear, or three or more gears. If a, b and c are the angles through which the sun gear 100, the ring gear 101 and the carrier frame 103 carrying the planet gears 102 have respectively rotated with respect to any initial configuration of the arrangement 199, the arrangement 199 ensures that the angles a, b and c satisfy the following relation:

$$c = \frac{a + b}{2} \qquad [ Math . 1 ]$$

Many different gear or machine arrangements can be imagined giving the above formula, and are within the scope of this invention. In an embodiment, the gear ratio of planet gear 102 with sun gear 100 is the same as the gear ratio of planet gear 102 with ring gear 101, to ensure that [Math. 1] is satisfied. The above may be achieved simply by using different gear teeth of planet gear 102, arranged in different planes to mesh with the sun gear 100 and ring gear 101. The above may also be achieved by using different tooth sizes for the sun gear 100 and ring gear 101, in such a way that they have the same number of teeth.

FIG. 1B depicts an arrangement 198 of gears according to an embodiment. Arrangements similar to arrangement 198 of gears may be referred to as “bevel type planetary gears”, “bevel type differential gears” or “differential gears” in the art. Planet gears 112 mesh with two bevel gears 110 and 111. The planet gears 112 are supported by a carrier frame 113 which rotates around the same axis that bevel gears 110 and 111 rotate around. If a, b and c are the angles through which the bevel gear 110, bevel gear 111 and carrier frame 113 have respectively rotated with respect to an initial configuration, the arrangement 198 ensures that the angles a, b and c satisfy the relation given in [Math. 1].

FIG. 1C depicts an arrangement 197 of gears according to an embodiment. Pinion gears 122 mesh with two circular rack gears 120 and 121 where the racks 124 and 125 are cut in the sides of circular discs. The meshing of the gears is not depicted for ease of understanding. 126 is a front view of the circular rack gear 121, having circular rack teeth 127 which is the front view of 125. The pinion gears 122 are supported by carrier frame 123 which rotates around the same axis that circular rack gears 120 and 121 rotate around. Even though two pinion gears 122 are depicted, more than two pinion gears may be used meshing with the same two circular rack gears, which will improve transmission of force. A single pinion gear may be used as well, which will save material. If a, b and c are the angles through which the circular rack gear 120, circular rack gear 121 and carrier frame 123 have respectively rotated with respect to an initial configuration, the arrangement 197 ensures that the angles a, b and c satisfy the relation given in [Math. 1]. Circular rack gears together with pinion gears as depicted are also known as face gears in the art. Face gears can be thought of as a limiting case of bevel gears. A similar arrangement, but with the circular rack gears and the pinion gear cut into cones rather than a plate and a cylinder, is called the bevel gear. In this invention, wherever face gears are depicted and disclosed, bevel gears may be used as well, by arranging gear teeth on cones rather than cylinders and plates.

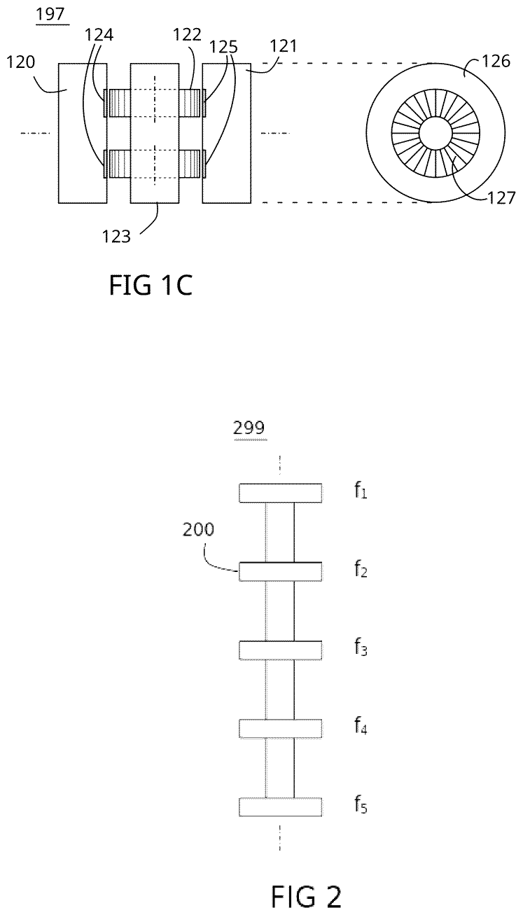

FIG. 2 depicts an arrangement 299 of many gears arranged in a particular fashion. Let f1, f2, . . . fn be the angles through which successive gears 200 have turned. The gears are arranged in such a fashion that

$$\begin{matrix}{f}_{2} = \frac{{f}_{1} + {f}_{3}}{2} \\ {f}_{3} = \frac{{f}_{2} + {f}_{4}}{2} \\ ⋮ \\ {f}_{n - 1} = \frac{{f}_{n - 2} + {f}_{n}}{2}\end{matrix} \qquad [ Math . 2 ]$$

These are n-2 equations in n unknowns. Each of the equations in [Math. 2] is an equation similar to [Math. 1], thus any of the techniques disclosed in the present disclosure to achieve [Math. 1] may be used to constraint the gears in the above fashion. From the equations in [Math. 2], we get

$$\begin{matrix}{f}_{2} - {f}_{1} = {f}_{3} - {f}_{2} \\ {f}_{3} - {f}_{2} = {f}_{4} - {f}_{3} \\ ⋮ \\ {f}_{n - 1} - {f}_{n - 2} = {f}_{n} - {f}_{n - 1}\end{matrix} \qquad [ Math . 3 ]$$

In other words, all consecutive differences are exactly the same. We may write this as

$${f}_{i} - {f}_{i - 1} = p \qquad [ Math . 4 ]$$

This leads to the conclusion that

$${f}_{i} = {f}_{1} + p ( i - 1 ) \qquad [ Math . 5 ]$$

Here p is the consecutive difference, but from the above, we may also write

$$p = \frac{{f}_{n} - {f}_{1}}{n - 1} \qquad [ Math . 6 ]$$

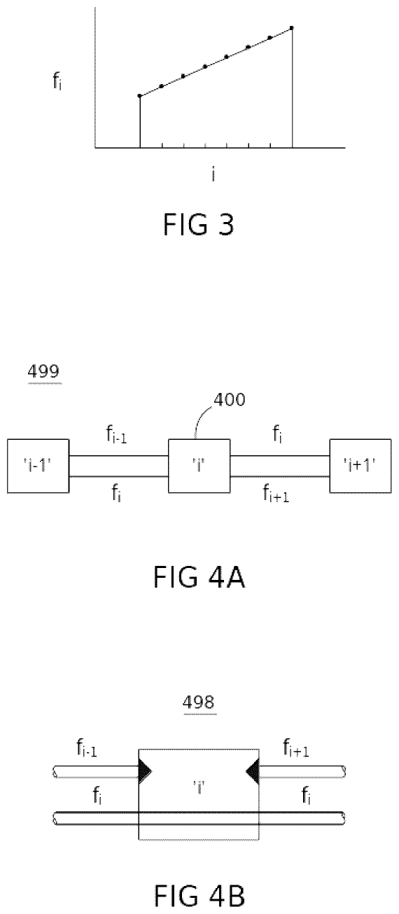

In other words, if f1 and fn were fixed to certain rotation amounts, this would fix p, and f1 and p thus being fixed, each fi would be fixed according to [Math 5].

[Math 5] implies that {fi} i is an arithmetic progression. (The mathematical symbol {fi} i stands for the sequence fi as a function of i.) Thus, setting the boundary angles f1 and fn sets the other angles in such a way that an arithmetic progression is formed. In other words, we get a linear interpolation from f1 to fn as depicted in FIG. 3.

Note that the fi variables have a topology of R (real numbers) not of S1 (a circle); e.g. 540 degrees and 180 degrees (1½ turns and ½ turns) are not considered to be the same. The fs remember not only the angle, but also how many turns were taken from the starting condition. The formulas are correct under this interpretation of the variables. Formulas in this disclosure can also be viewed to be correct under the alternative interpretation that the variables only describe angle devoid of number of turns, in which the mathematical operations ‘+’ and ‘=’ are then taken to be modulo 360 degrees. The mathematics of the present invention remains true under either interpretation, and various applications can utilize either of the two interpretations.

FIG. 3 depicts a linear relation between angle variables according to an embodiment. The angle variables fi are depicted as a function of i. The fis stand for the angles by which gears from consecutive units in a gear train have turned by. As described by [Math 5] the fis form an arithmetic progression, i.e. are linearly dependent on i.

### Mechanical Arrangement

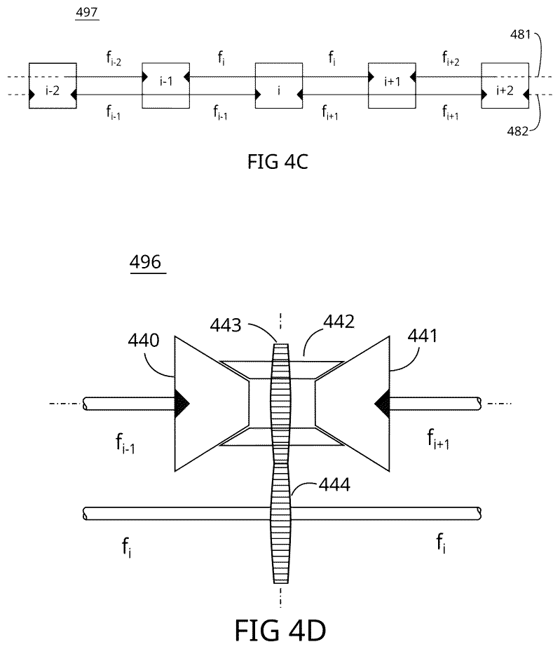

FIG. 4A depicts a mechanical arrangement 499 of gear boxes in a schematic fashion. Every planetary gearbox (say gearbox i depicted by box 400) requires access to mechanical variables fi−1, fi, fi+1. In an embodiment the mechanical variables fi−1, fi, fi+1 are connected to the gearbox as an axle or any turning rigid body. In another embodiment, the mechanical variables may be connected using belts, or racks or rods that are pushed or pulled rather than turned.

FIG. 4B depicts gearbox i 498 in schematic fashion. Gearbox i 498 is mechanically constrained to follow the following law

$${f}_{i} = \frac{{f}_{i - 1} + {f}_{i + 1}}{2} \qquad [ Math . 7 ]$$

using the various embodiments of the present invention. This is symbolically depicted by the presence of shaded triangles next to the axles fi−1 and fi+1. There is no shading on fi which is the angle that is the average of the two other angles. Furthermore, the axle corresponding to fi is depicted as passing through the gearbox, in other words, is depicted as its output being available on more than one ports, these ports being at opposite sides of the gearbox in an embodiment. The two shaded ports may also be at opposite sides of the gearbox.

FIG. 4C depicts an interpolating gear train 497 according to an embodiment. This figure uses the schematic notation of FIG. 4B, i.e. the axle passing through the gearbox is constrained to be turned by an amount equal to the average of the two turns of the axles having shaded triangles. The gear train 497 follows the law [Math. 7] for every i, which means it follows the set of equations [Math. 2]. Thus, the gear train 497 creates an arithmetic progression {fi} i of angles as described by the equation [Math. 5]. The schematic diagram of FIG. 4C depicts connections between gearboxes on two parallel lines, line 481 and line 482. These two schematic parallel lines can be implemented in various embodiments in various manners. For example, they could be geometric parallel lines, with axles arranged along those parallel lines. Alternatively, the two axles that go from any gearbox to an adjacent one may be concentric axles, with one of the parallel lines depicting an inner axle and the other parallel line depicting an outer axle. The outer axle of the concentric axles may be physically realized as a cylinder, or alternatively as two or more rods or rigid bodies rotating around an axis external to the rods. Throughout this invention, any rotating apparatuses such as axles, rotating bodies, gears etc. may be supported by bearings or bushings.

FIG. 4D depicts a gearbox 496 according to an embodiment. The gearbox 496 satisfies the mechanical constraints required by the schematic gearbox 498 of FIG. 4B many instances of which are used in the gear train 497 of FIG. 4C. The bevel gears 440 and 441, the planet gears 442 and the carrier frame 443 are as described in conjunction with FIG. 1B. The planet gears 442 are connected to the carrier frame 443 which is a rotating ring. On the outer surface of this carrier frame 443 rotating ring, gear teeth are provided, which mesh with and rotate another gear 444. Alternatively, the carrier frame 443 is affixed to a gear that meshes with and rotates gear 444. The gear 444 is mechanically constrained by this arrangement to turn an amount which is the average of the amounts that the bevel gears 440 and 441 turn by, i.e. the rotations labeled fi−1, fi and fi+1 follow [Math. 7]. For the above to be true, the angle of turn of gear 444 (fi) and of gears 440 (fi−1) and 441 (fi+1) is measured using opposite senses, e.g. clockwise and anti-clockwise respectively or vice-versa, as seen from a specific side of gearbox 496. There are many other mechanical embodiments with the same mathematical effect.

FIG. 4E depicts gearbox i 495 in schematic fashion. Gearbox i 495 is mechanically constrained to follow the law given in [Math. 7] using any of the embodiments of the present invention. The convention of drawing the schematic figure is, the unshaded variable fi is mechanically constrained to have a rotation equal to the average of the shaded variables fi−1 and fi+1. The mechanical arrangement is such that the shaded variables fi−1 and fi+1 are offset with respect to each other, and are mechanically opposite to two mechanical ports each carrying a copy of the unshaded variable fi. Shading is depicted as a shaded triangle in FIG. 4E, which is a schematic representation of the law given in [Math. 7] as explained above, realized using any of the embodiments of the present invention.

FIG. 4F depicts an interpolating gear train 494 according to an embodiment. This figure uses the schematic notation of FIG. 4E, i.e. the unshaded axles are constrained to turn by an amount equal to the average of the two turns of the axles having shaded triangles. The gear train 494 thus follows [Math. 2] creating an arithmetic progression {fi} i of angles. The schematic diagram of FIG. 4F depicts connections between gearboxes on two parallel lines, line 483 and line 484. These two schematic parallel lines can be implemented in various embodiments in various manners. For example, they could be geometric parallel lines, with axles arranged along those parallel lines. Alternatively, the two axles that go from any gearbox to an adjacent one may be concentric axles, with one of the parallel lines depicting an inner axle and the other parallel line depicting an outer axle.

FIG. 4G depicts an interpolating gear train 492 according to an embodiment. Interpolating gear train 492 has multiple gearboxes such as gearbox 491 arranged sequentially. Gearbox 491 has bevel gears 450 and 451 meshing with planet gears 452 mounted on a rotating carrier frame 453. The carrier frame 453 has a gear attached to (or cut into) its exterior which meshes with gears 454 and 455. The rotations of the gears 454 and 455 are available as the ‘fi’ ports on either side of the gearbox 491, which is the i gearbox, and the rotations of bevel gears 450 and 451 are available as shaded variables ‘fi−1’ and ‘fi+1’. Gearbox 491 can thus be considered similar in functionality to the schematic gearbox of FIG. 4E. As depicted, the gearbox 491 connects to similar gearboxes on one or both sides, with shaded variables connecting to unshaded ones and vice versa, which creates the functionality depicted in schematic form in FIG. 4F. The gear train 492 thus follows [Math. 2] creating an arithmetic progression {fi}i of angles.

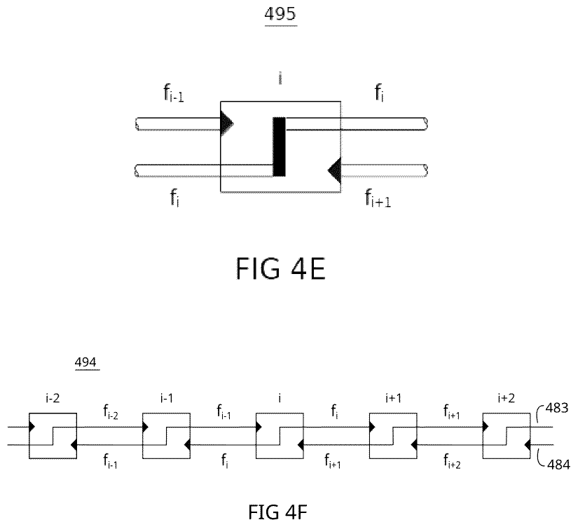

FIG. 5A depicts a gearbox 599 with concentric axles according to an embodiment. Planet gears 502 are fixed to a planet axle 503 (shaded) which is concentrically outside of axle 505 of sun gear 500 and axle 506 of ring gear 501. The planet gears 502 mesh with the sun gear 500 and ring gear 501 (even though such meshing is not depicted in the diagram for case of understanding the diagram).

FIG. 5B depicts a gearbox 598 with concentric axles according to an embodiment. Planet gears 512 are fixed to a planet axel 513 (shaded) which is concentrically inside of axle 515 of sun gear 510 and axle 516 of ring gear 511. The planet gears 512 mesh with the sun gear 510 and ring gear 511. The gearbox 599 of FIG. 5A and the gearbox 598 of FIG. 5B are complementary. In an embodiment, they are alternated with each other on a single straight axis, with the concentric axes rigidly connected to each other, which produces mechanisms of the schematic depicted in FIG. 4C.

FIG. 5C depicts a gearbox 597 according to an embodiment. The planet gears 522 are fixed to the planet axle 523 (shaded) which is concentrically inside of the axle 526 of ring gear 521 and concentrically outside of the axle 525 of sun gear 520. The planet gears 522 mesh with the sun gear 520 and ring gear 521. The gearbox 597 fits into itself to create an interpolating gear train. In an embodiment, an interpolating gear train comprises many gearboxes 598 placed one after the other on a single axis, with the respective concentric axes rigidly connected.

FIG. 5D depicts a gearbox 596 with concentric axles according to an embodiment. Axles of planet bevel gears 532 are fixed to a planet axle 533 (shaded) which is concentrically outside of axle 535 of bevel gear 530 and axle 536 of bevel gear 531. The planet bevel gears 532 mesh with the bevel gear 530 and bevel gear 531 (even though such meshing is not depicted in the diagram for ease of understanding the diagram). The planet axle 533 is a pipe concentric with the axles 536 and 535. Instead of a pipe, it could also be any rigid body, such as multiple rods. The planet axle is large enough in parts to accommodate the bevel gear arrangement—this may be accomplished by enlarging the diameter of the pipe to accommodate the bevel gear arrangement. FIG. 5D satisfies the requirements of the gearbox of FIG. 4B.

FIG. 5E depicts a gearbox 595 with concentric axles according to an embodiment. Axles of planet bevel gears 542 are fixed to a planet axle 543 (shaded) which is concentrically inside of axle 545 of bevel gear 540 and axle 546 of bevel gear 541. The planet bevel gears 542 mesh with the bevel gear 540 and bevel gear 541 (even though such meshing is not depicted in the diagram for ease of understanding the diagram). The planet axles 545 and 546 are pipes concentric with the axle 543. Axle 543 is a single rigid axle passing from the left to the right of the depiction. Instead of pipes, the axles 545 and 546 could also be any rigid body, such as multiple rods. The bevel gears 540 and 541 have holes in their center to allow axle 543 to pass through them. The bevel gears 540 and 541 turn separately from axle 543. FIG. 5E satisfies the requirements of the gearbox of FIG. 4B. The gearbox 596 of FIG. 5D and the gearbox 595 of FIG. 5E are complementary. In an embodiment, they are alternated with each other on a single straight axis, with the concentric axes rigidly connected to each other, which produces mechanisms of the schematic depicted in FIG. 4C.

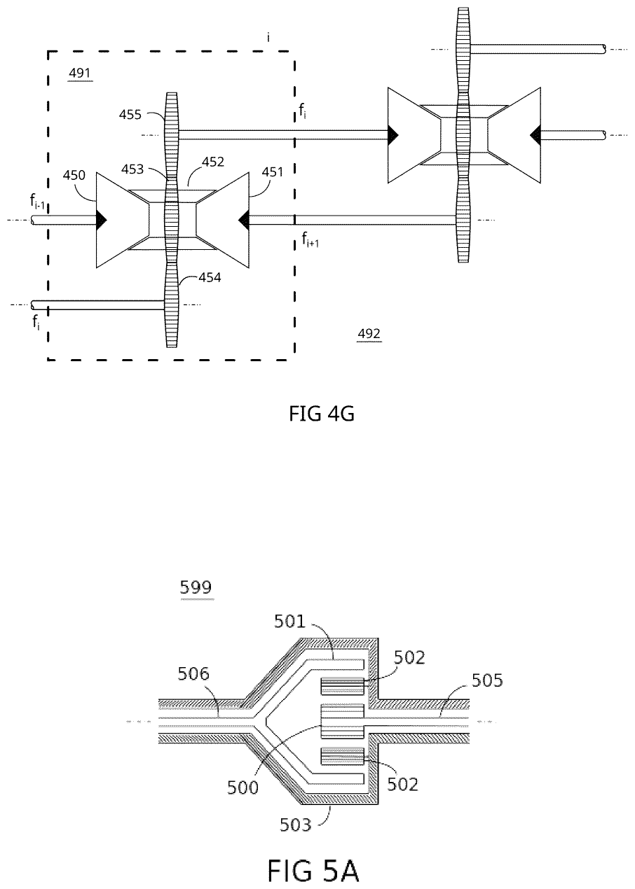

FIG. 6A depicts an interpolating gear train 699 according to an embodiment. The shaded axle 623 is a single axle. The axle 623 has planet gears 622 attached to it. The axle 623 also has a sun gear 620 provided on one end of the axle and a ring gear 621 provided on the other end. Many such axles are situated adjacent to each other on a single axis in such a way that the planet gears of one axel mesh with the ring gear of the axel on one side and with the sun gear of the axel on the other side.

FIG. 6B depicts an interpolating gear train 698 according to an embodiment. The shaded axle 613 is a single axle. The axle 613 has planet bevel gears 612 pinned to it. The axles of planet bevel gears 612 are rigidly connected to the axle 613, and the bevel gears 612 are free to rotate about their axles. The axle 613 has a bevel gear 610 and a bevel gear 611 rigidly connected to it. The bevel gears 610 and 611 engage planet bevel gears of the next and previous gearboxes (i.e. attached to next and previous axles), whereas the bevel gears attached to next and previous gearboxes engage the planet bevel gears 612. The bevel gear 611 has a hole in its center allowing an adjacent axle to pass through it. Similarly, the axle 613 passes through the hole of an adjacent bevel gear. Many such axles are situated adjacent to each other on a single rotation axis. The interpolating gear train 698 realizes the schematic of FIG. 4F.

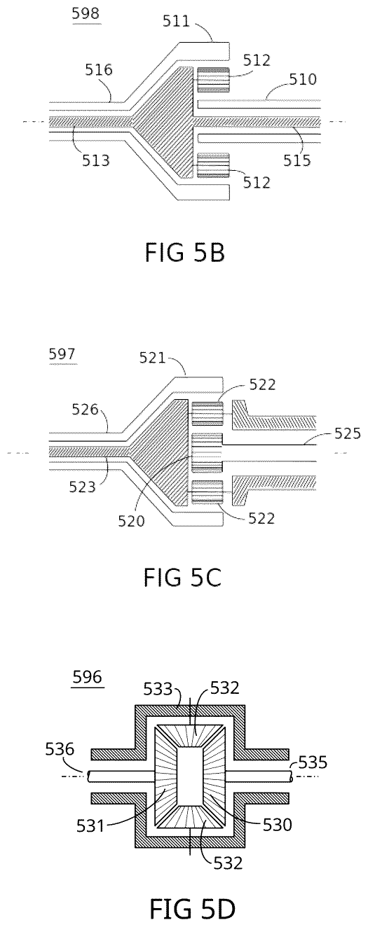

FIG. 7 depicts an interpolating gear train 799 using beveled gears in a tight configuration, according to an embodiment. The part 705 shaded by hatching is a single rigid solid piece, having two beveled gears 700 and 701 and a gear 704. The part 706 shaded with a dotted pattern is a piece having three parts-one gear 703 and two beveled planetary gears 702. The beveled planetary gears 702 are embedded inside gear 703, and free to move on their own axis. In other words gear 703 acts as the carrier frame for bevel gears 702. The part 705 and part 706 together form a single gearbox in the gear train. Such gearboxes are placed consecutively in alternating orientations. In other words the solid part 705 will mesh with adjacent planetary gears whereas the planetary gears 702 will mesh with adjacent solid parts.

The top gear faces provide the fs that are an arithmetic progression (i.e. create a linear interpolation). This gear train is easy to manufacture, easy to assemble, compact and robust.

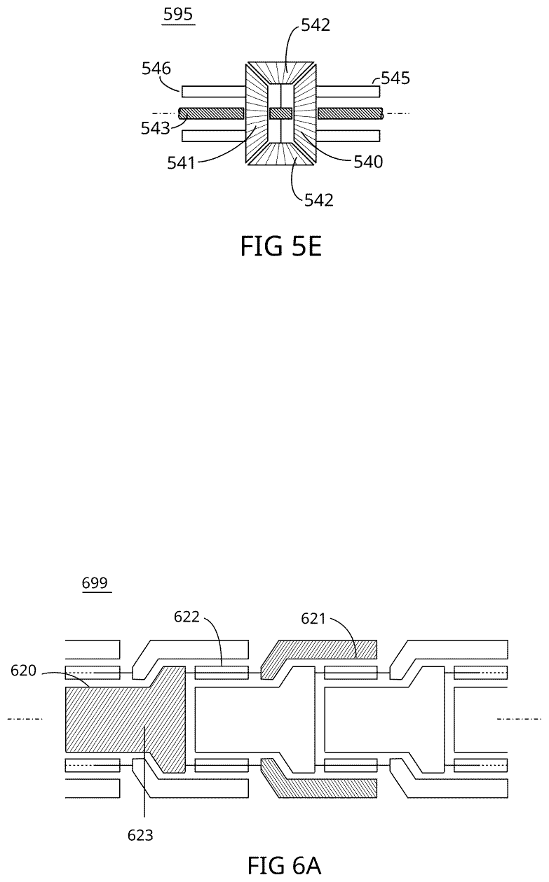

FIG. 8 depicts an interpolating gear train using non-beveled gears in a tight configuration, according to an embodiment. The part 805 shaded with a dotted pattern is a single rigid solid piece. Part 805 is a cylindrical disc having a gear 808 on its curved face and serrations on its two circular faces creating circular racks 800 and 801. The circular racks 800 and 801 engage the small planetary gears 802a and 802b on either side. The part 806 shaded with a diagonal pattern is a piece having three parts-one disc gear 804 and two small disc-shaped planetary gears 802, which rotate around their own axis, an axis that is rigidly fixed to the disc gear 804, thus making disc gear 804 the carrier frame for the planetary gears 802. The planetary gears 802 mesh with and churn between the circular racks 801a and 800b on the sides of the adjoining discs. The part 805 and part 806 together form a gearbox in the gear train. Such gearboxes are placed adjacent to each other in alternating orientations as depicted. In other words, two rows of disc gears are provided, each row of gears rotating on a specific axis. Each gear meshes with a corresponding gear on the other row. Alternate gears in each row are provided with a circular rack and a disc shaped planetary (pinion) gear, in such a way that a gear with a circular rack on one row engages with a gear with a planetary gear on the other row and vice versa.

The top gear faces provide the fs that are an arithmetic progression (i.e. create a linear interpolation). This gear train is easy to manufacture, easy to assemble, compact and robust. The circular rack gears and disc shaped planetary gears may be called face gears. Beveled gears may be used in place of such face gears.

Some applications are load bearing whereas others are only signal bearing. For such signal bearing applications, the force endured by the gears etc may not be a concern. In such cases we could make these gear trains from cheap plastic and mold them rather than machine them. To get accuracy, we can gear down the signal at the output of the gear train which is the input to the application. In other words, many many turns of the gears creating the signal outputs {fi} i cause a very tiny change of the output. This reduction of gear speed may be performed using disc gears, worm gears, worm-and-rack gears, or any speed reduction gearing mechanism known in the art.

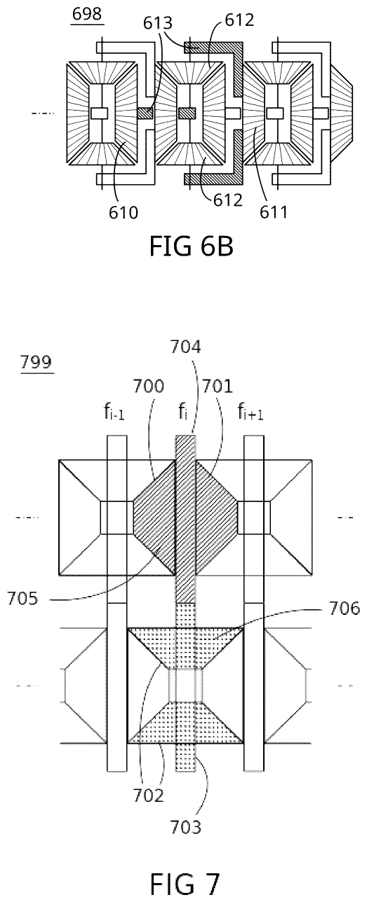

FIG. 9 depicts an output gear 999. Gear 999 is to be used as the output gear of the gear train such as the gear train 899 of FIG. 8, according to an embodiment. The gear has a toothed gear pattern 904 and a worm pattern 907 both cut into it. The lower gears mesh into the toothed pattern 904, whereas an application gear 908 meshes into the worm pattern 907. The worm-type engagement causes the application 908 to turn slowly compared to the output gear 999, thus increasing precision of controlling the application. The worm pattern 907 together with the application gear 908 form a worm gear type arrangement. The toothed gear pattern 904 and a similar toothed pattern on another lower gear (not shown) form a pair of spur/disc gears. This other lower gear does not have a worm pattern on it, or if it does, both the worm pattern 907 and the worm pattern on the other gear have narrower valleys than hills (narrower flank than face), thus ensuring that the spur gear engagement is not hampered.

### Interpolating Gears of Higher Orders

According to an embodiment, interpolations of not just linear but higher polynomial orders is achieved. In principle, interpolation of arbitrary order may be achieved.

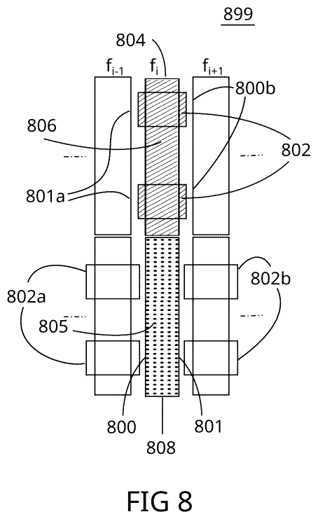

FIG. 10 depicts a differential gearbox 1099 in schematic form, according to an embodiment. The differential gearbox denoted D connects three rotations fi(k), fi+1(k), fi(k−1) by creating a fixed relation between them. The fixed relation may be that the rotation fi(k−1) is a linear combination of rotations fi(k) and fi+1(k). In an embodiment, the relation between the three rotations (possibly presented to the gearbox as three axles, or any means disclosed in this disclosure) is

$$c {f}_{i}^{( k - 1 )} = {f}_{i + 1}^{k} - {f}_{i}^{k} \qquad [ Math . 8 ]$$

In a particular embodiment, the constant c=2, but other constants may also easily be created by using gear ratios appropriately. The rotational variables fi(k), fi+1(k) are rotational variables on the same row, whereas rotational variable fi(k−1), is a rotational variable on a different row. According to this convention, rotational variables with a given superscript are rotational variables on a given row, which, when part of an appropriate gear network, will be constrained to produce a polynomial order equal to the row number. I.e. rotational variables with a superscript (k) will be constrained to produce a polynomial of order k.

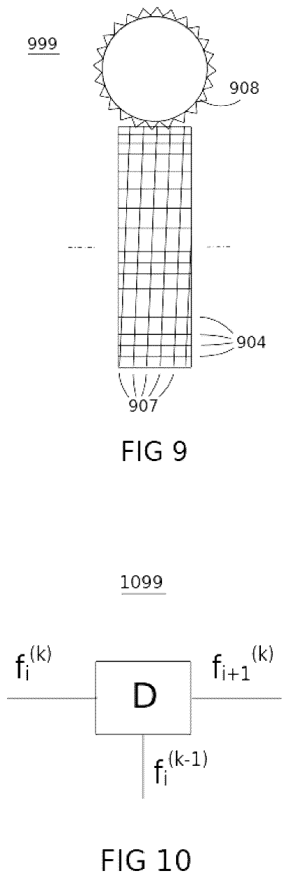

FIG. 11 depicts a network 1199 of differential gearboxes in schematic form, according to an embodiment. Each gearbox denoted D is a box like the differential gearbox 1099 as described in FIG. 10. The lines 1100 between the gearboxes imply the same rotation being provided to more than one gearboxes. A “circuit connector dot” like dot 1101 is shown to depict more than two gearboxes receiving the same rotation.

The differential gearboxes, marked D are arranged in one or more rows 1109, such as rows 1110, 1111 and 1112, each row comprising one or more differential gearboxes. In this schematic, the rotational variables with a particular superscript are arranged in a single row. Adjacent gearboxes on the same row have their rotational variables tied together by rotation transference mechanisms such as axles, linkages, chains or belts. If the same-row rotational variables corresponding to a differential gearbox are termed as the left rotational variable and the right rotational variable, the left rotational variable is mechanically tied to the right rotational variable of an adjacent differential gearbox on the same row. This rotational variable is furthermore tied to a differential gearbox on the adjacent next row. The rotational variables corresponding to a particular row are mechanically tied to the different-row input of a differential gearbox on the next row. In an embodiment, the rotational variables of a particular number of a particular row (such as row 1110) are tied to the different-row input of the same numbered differential gearbox on the next-numbered row (such as row 1111). In an embodiment, each row has one more rotational element than differential gearboxes. Each rotational element of a particular row is attached to the different-row input of a differential gearbox on the next row. Thus, for each row, there is one more differential gearbox on the next row than there is on this particular row.

In an embodiment, one low-k row is further constrained in one of the following ways. Either the row k=−1 is constrained such that

$${f}_{i}^{( - 1 )} = 0 \qquad [ Math . 9 ]$$

or the row k=0 is constrained such that

$${f}_{i}^{( 0 )} = a \qquad [ Math . 10 ]$$

for some single settable rotation a, or the row k=1 is constrained such that

$${f}_{i}^{( 1 )} = b i + d \qquad [ Math . 11 ]$$

for a pair of settable constants b and d. (By settable, we mean that these are degrees of freedom, not that these will be provided to the mechanical circuit as external inputs.) For example [Math 9] can be achieved by mechanically fixing each fi(−1), or [Math 10] can be achieved by tying all fi(0) by a link/rod/shaft, or [Math 11] can be achieved by using a linearly interpolating gear train as described in this patent. In these situations, the low-k row in question is not a row of similar kind of gearboxes as the higher rows, but directly the fixture, the link/rod/shaft or linearly interpolating gear train, as appropriate. In an embodiment, a k higher that 1 may be set directly; the general rule being to constrain just one k, and to constrain it to interpolate with a polynomial of order k. In an embodiment, the k that is thus constrained is the lowest k in the gear network 1199.

If {fi(k−1)} i is a polynomial of order k−1 evaluated at the various integers i, then {fi(k)} i is a polynomial of order k evaluated at the various integers i. Furthermore, if any polynomial of order k−1 can be created on the {fi(k−1)} i then any polynomial of order k can be created on the {fi(k)} i. These facts can be proved from equation [Math 8]. From the above facts, using mathematical induction, we can prove the following statement:

Let k′<k be two integers. If {fi(k′)} i is constrained to be a polynomial of order k′ evaluated at the various integers i, then {fi(k)} i is constrained to be a polynomial of order k evaluated at the various integers i. If any polynomial of order k′ can be created on {fi(k′)} i then any polynomial of order k can be created on {fi(k)} i.

Thus, if we can constrain a low-k row to be a polynomial of order k, each higher-k row gets automatically constrained to form a higher order polynomial, and there are no further constraints on the polynomials that can be created. In an embodiment, the gear train produces quadratic interpolation, with the row k=2 being a row as depicted in FIG. 11. The row k=1 may be a linearly interpolating row as depicted in FIG. 4C or FIG. 4F, or may also be a row as depicted in FIG. 11. If the row k=1 is as depicted in FIG. 4C or FIG. 4F, a row k=0 is not required, but if it is as depicted in FIG. 11, then a row k=0 may be as described above. The row k=0 may also be as depicted in FIG. 11, in which case the row k=−1 is a row of zero rotations (i.e. the corresponding gears of k=0 are fixed). Thus, a quadratic interpolation can be produced by using one, two or three rows of the gearboxes D, coupled with appropriate mechanical techniques. Similarly, a cubic interpolation can be produced using two, three or four rows of gearboxes D (which would be a row of D gearboxes above the quadratic interpolation gearboxes). In general, interpolation of order p can be produced using p−1, p or p+1 gearboxes.

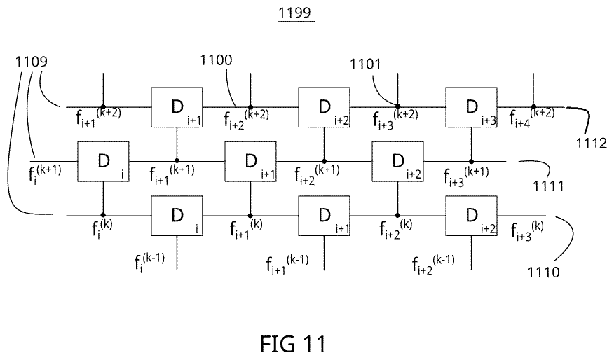

FIG. 12 depicts a mechanical apparatus 1299 that performs as a differential gearbox according to an embodiment. The mechanical apparatus 1299 may be used as the differential gearbox D of FIG. 10, to be used in the gear network 1199 of FIG. 11. The mechanical apparatus 1299 satisfies equation [Math 8] with c=2. Planet gears 1202 move between beveled gears 1200 and 1201 (or alternatively churn between circularly racked parallel wheels). The beveled gears 1200 and 1201 have disc gears 1204 and 1205 attached rigidly to them. The axes of planet gears 1202 are attached to a carrier frame 1203 having a gear arranged on its outer surface. The carrier frame 1203 takes input fi(k−1) and thus acts as −fi(k−1) (the negative sign indicating the change of direction of rotation of the carrier frame 1203 with respect to the gear meshing with it (not shown)) and the disc gears 1204 and 1205 act as fi(k) and −fi+1(k) respectively. A gear 1206 meshing with gear 1205 produces the output fi+1(k). In an embodiment, the gear 1206 may not be part of the gearbox D, but may be a gear of the next gearbox on the same row. As described with respect to FIG. 1B, the carrier frame 1203 rotates as an average of the beveled gears 1200 and 1201 (and thus of the disc gears 1204 and 1205). This may be mathematically written as −fi(k−1)=(fi(k)+(−fi+1(k))/2, which implements [Math. 8]. Thus the gearbox 1299 is a mechanism that implements the schematic differential gearbox D depicted in FIG. 10 and used in FIG. 11.

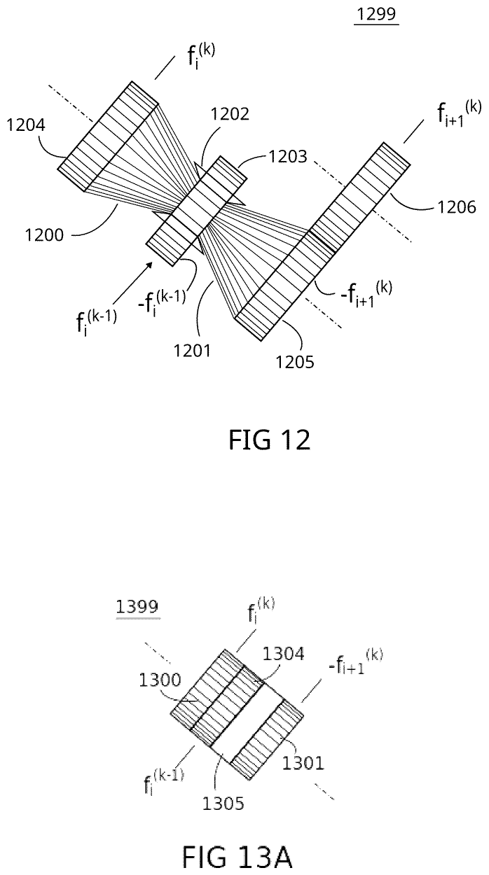

FIG. 13A depicts a gearbox 1399 as viewed from outside, according to an embodiment. The carrier frame 1304 having a gear (pinion, face or planet gear-internal, not shown) is placed between gears 1300 and 1301. The carrier frame 1304 also has an external gear on it (shown). The gear on the carrier frame 1304 is not placed centrally between gears 1300 and 1301 but shifted to one side. In an embodiment, there is a gap 1305 between the gear on the carrier frame 1304, and one of the gears 1301. The gap 1305 may be equal in width to the gears 1301 and 1300 as well as the gear on the carrier frame 1304, or larger than this width. If a, b and c are respectively the angles by which the gear 1300, gear 1301 and carrier frame 1304 turn, this gearbox implements the constraint [Math 1]. It may do this by internally implementing a mechanism like the arrangements 199, 198 or 197 of FIG. 1A, FIG. 1B or FIG. 1C respectively. The gear on the carrier frame 1304 is constrained to turn by an angle equal to the average of the angles that gears 1300 and 1301 turn by.

The gear on the carrier frame 1304 is connected to the fi(k−1) input and thus rotates according to −fi(k−1), whereas the gear 1300 is the fi(k) input. The gear 1301 is −fi+1(k). The negative sign will be corrected by a gear that meshes with gear 1301 and corrects the sign thus creating fi+1(k) (not depicted). As will be seen in FIG. 13B, a gear of a meshing gearbox itself performs that function.

FIG. 13B depicts a mechanical arrangement 1398 made out of the gearboxes of FIG. 13A according to an embodiment. In an embodiment, the gearboxes such as gearbox 1310 in one horizontal row are of one k. The row is horizontal, but the gearboxes are oriented slant. Such a single row of gearboxes is shown separately as row 1397, with the functionality of each gearbox in the row similar to the functionality shown in FIG. 12 or FIG. 13A. The gearboxes mesh in a way that the network of FIG. 11 is created. Single gears such as gear 1311 are used in terminal locations. (In an embodiment, we may use the entire differential unit as well, but everything in it but one gear will not be utilized.)

Various gearboxes like gearbox 1310 are placed on an axle such as axle 1312. A single axle can take multiple differential gear units. Units on a single axle have the same value of the number i+k. It is possible to lock the terminal gear onto this axle (or mold it into the axle) so that these terminal gears can be controlled by turning the axle. In this way, both the low-k condition as well as the polynomial control can be set. The other gears are not locked into the axle, but rotate freely on it.

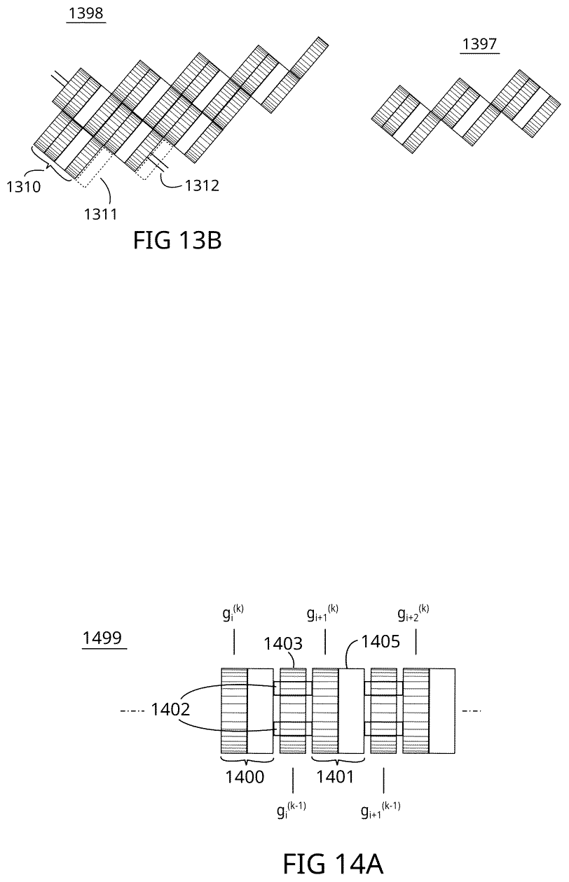

FIG. 14A depicts one row 1499 of an interpolating gear network according to an embodiment. This embodiment is another way in which the equation [Math 8] may be implemented. Consider the transformation

$${g}_{i}^{( k )} = {( - 1 )}^{i} {f}_{i}^{( k )} \qquad [ Math . 12 ]$$

Substituting [Math. 12] in [Math. 8] gives

$${c ( - 1 )}^{i} {g}_{i}^{( k - 1 )} = {( - 1 )}^{i + 1} {g}_{i + 1}^{( k )} - {( - 1 )}^{i} {g}_{i}^{( k )} \qquad [ Math . 13 ]$$

which simplifies to

$$c {g}_{i}^{( k - 1 )} = - {g}_{i + 1}^{( k )} - {g}_{i}^{( k )} \qquad [ Math . 14 ]$$

We may now implement equation [Math 14] mechanically, and only recover the final fs using inverting gears as required to implement [Math. 12]. We may also choose every alternate output from the gs, which match the fs. Equation [Math. 14] can be implemented mechanically: one way to implement it is to implement the averaging scheme of equation [Math. 1] which will correspond to c=2, as shown below.

In an embodiment, the equation [Math. 14] is implemented as shown in FIG. 14A. Some discs 1403 with gears have small planet discs 1402 (pinion gears) embedded in them, which churn between circular racks (together forming face gears) on the adjoining discs 1400 and 1401. Discs with planet gears alternate with discs with circular racks. We may casily merge such rows together as shown in FIG. 14B. The discs with circular racks such as discs 1400 and 1401 have gears on their exterior, limited to one part of the disc. Another part of the disc has a gap, such as gap 1405, with no gear teeth. In place of the face gear (circular rack and pinion) arrangement, beveled gears may be used as well, providing similar functionality. Due to the gear arrangement, the disc 1403 moves equal to the average of the discs 1400 and 1401. Assuming discs 1400 and 1401 move equal to gi(k) and gi+1(k), and that disc 1403 takes as a gear-meshed input the rotation variable gi(k−1), thus turning by −gi(k−1), this implies that −gi(k−1)=(gi(k)+gi+1(k))/2 which is the same as [Math. 14] for c=2.

FIG. 14B depicts a compact interpolating gear network 1498 according to an embodiment. Rows 1420, 1421 and 1422, similar to the row 1499 of FIG. 14A mesh with each other in such a way as to implement [Math 14]. There are multiple rows, sequentially numbered. Each row has an alternating pattern of discs (such as disc 1413) having embedded pinion gears or bevel gears free to spin on their own axes, alternating with discs such as discs 1410 and 1411 having circular racks (not shown) or bevel gears molded or cut into the discs or attached to the discs. The circular racks and embedded pinions mesh with each other to form face gears. Alternatively, the embedded and molded/cut bevel gears mesh with each other to create a similar functionality. The functionality of FIG. 1B or FIG. 1C is thus created. In each row, the external gear on a disc having pinion gears (or embedded bevel gears free to spin on their own axes), such as the external gear on disc 1413 meshes with corresponding gears having circular racks (or bevel gears molded/cut into the discs) from a lower-numbered row. The discs having circular racks (or bevel gears moulded/cut into the discs) such as discs 1410 and 1411 mesh with corresponding gears having pinion gears (or embedded bevel gears free to spin on their own axes) from a higher-numbered row. At the input, the condition gi(−1)=0 can be provided by locking the corresponding input gears. The other input conditions corresponding to [Math. 10] or [Math. 11] may also be provided. To provide input conditions corresponding to [Math. 10], set gi (0)=(−1)ia. This may be done by providing two sets of gears, constrained to rotate by the same amount in opposite directions. The output will be in the form of g so if f is needed for the application, we will have to invert every alternate output. This can be done by extra gearing, or by meshing output racks alternately to the opposite sides of the output gears (which act as pinions for extracting the interpolated signal). Alternatively, only alternate outputs may be chosen as f, and the other alternate outputs (corresponding to values of −f) are dropped.

### Further Augmentation

We can create a 2D array of such interpolating gears. In one embodiment, the 2D array produces a bilinear interpolation. In another embodiment, the 2D array is a 2D linear interpolation. Bilinear interpolation is achieved by making interpolating linearly both horizontally and vertically. In an embodiment, interpolation in one of the two directions only happens at the edges. In another embodiment, the interpolation in both directions happens at all gear boxes. The bilinear interpolation may also be used as a linear interpolation by using a special control strategy or a mechanism. Higher polynomial order interpolation 2D gear arrays may be created as well. For example, quadratic or bi-quadratic interpolation; cubic or bi-cubic interpolation and so forth. Similarly, 3D arrays of interpolating gears may also be made. The entire 1D, 2D or 3D array may be bathed in a bath of oil or lubricant for smooth operation and for protecting the mechanism.

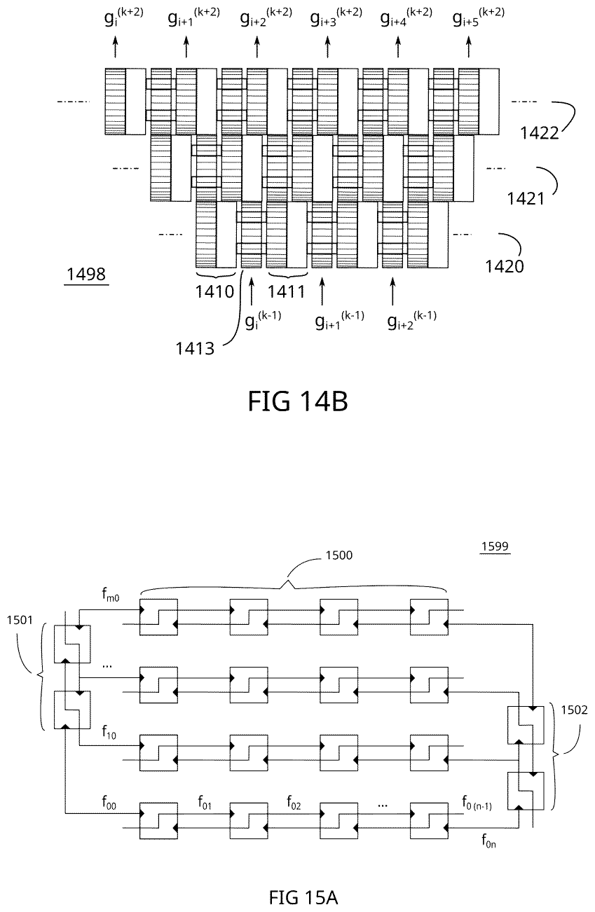

FIG. 15A depicts a 2D array bi-linear interpolation gear network 1599 as a schematic, according to an embodiment. Each gearbox (depicted as a square) performs the function described for gearbox 495 of FIG. 4E. Interpolating gear trains such as interpolating gear train 1500 are placed parallel to each other and fed constraints from interpolating gear trains 1501 and 1502 which are placed to the two sides and arranged in a perpendicular direction to interpolating gear trains 1500. The interpolating gear train 1501 creates the constraints fi0=ai+b. The interpolating gear train 1502 creates the constraints fin=ci+d, where n−1 is the number of gearboxes in each interpolating gear train 1500 giving number of variables n. Interpolating between these two, the interpolating gear trains 1500 create the interpolation fij=fi0+(j/n) (fin−fi0)=b+ai+ [(d−b)/n]j+[(c−a)/n] ij. This is seen to be general bilinear interpolation. If we set the four rotations in four corners, f00, fm0, fon, fmn, all the values of a, b, c and d will be fixed, thus fixing the bilinear interpolation. This general bilinear interpolation can be further constrained to be a general linear interpolation by constraining c=a, thus making the ij term zero, creating a general linear function of i and j. There are many ways of achieving this, and one way will be by ensuring that fm0−f00=fmn−f0n. This is a mechanical constraint that can be set by taking the difference using two differentials and equating them using a linking rod. In this case, with this extra linkage, only three free parameters remain, and only three rotations need to be controlled. c=a may also be ensured by a control strategy rather than a mechanical constraint, i.e. four rotations are set by actuation mechanisms, but they are always set in such a manner that c=a is satisfied.

In an embodiment, rather than gear trains 1501 and 1502 being parallel to each other, are placed in such a way that one of their ends is the same set of variables. This may be used to control a triangular rather than a rectangular patch, but the rows of the triangle may be extended to a rectangle or any suitable shape. (Similarly the rows 1500 of the rectangle of the present embodiment may also be extended to extrapolate beyond the extents of their interpolation.) This will ensure linear rather than bilinear interpolation.

Similarly, other strategies can be implemented. For example, to create bi-quadratic interpolation, the gear trains 1501 and 1502, and another gear train placed parallel to them are all quadratic interpolation gear trains (according to other embodiments of this invention), and the gear trains 1500 are also quadratic interpolation gear trains. A bi-quadratic gear network may be used for quadratic interpolation by adding constraints mechanically or as a control strategy. To create quadratic-linear interpolation, the gear trains 1501 and 1502 are quadratic interpolation gear trains and the gear trains 1500 are linear interpolation gear trains.

FIG. 15B depicts a 2D array interpolation gear network 1598 as a schematic, according to an embodiment. Horizontal rows such as row 1550 each comprise multiple gearboxes schematically marked ‘D’. (The words ‘horizontal’ and ‘vertical’ are used for ease of explanation; any two orientations, mutually perpendicular or otherwise may be used in this embodiment.) The horizontal row such as row 1550 are constrained to create a polynomial of a particular order (the horizontal order). This is done using embodiments such as the embodiment of FIG. 11, or related embodiments. (The lower order rows of FIG. 11 are not displayed in FIG. 15B, only the highest-order row is displayed as a horizontal row the other lower order rows exist connected appropriately to each horizontal row, but are not pictured.) Vertical rows such as rows 1551, 1552 and 1553 each comprise multiple gearboxes schematically marked ‘D’. The number of vertical rows is one more than the order of interpolation of each horizontal row. Thus, if the horizontal rows are constrained to interpolate quadratically (order 2), there are three vertical rows (as depicted). The vertical rows are attached to distinct vertical sets of the rotation variables of the horizontal rows. In an embodiment, the vertical rows are spaced equally, or as equally as possible. In an embodiment, the extremal vertical rows are attached to the extremal (i.e. first and last) rotation variables of the horizontal rows. The vertical rows are constrained to create a polynomial of a particular order (the vertical order) which may or may not be the same as the horizontal order. (The lower order rows of FIG. 11 are not displayed in FIG. 15B, only the highest-order row is displayed as a vertical row; the other lower order rows exist connected appropriately to each vertical row, but are not pictured.) In an embodiment, the vertical rows are parallel to each other. In another embodiment, the vertical rows are transverse to the horizontal rows, but not all parallel to each other; they are at different orientations, possibly even touching or crossing each other, thus reducing a degree of freedom. Various interpolation schemes can thus be created. For example, if both the horizontal and vertical interpolation order is 2, the gear network is constrained to perform a bi-quadratic interpolation. If one of the orders is 1 and the other is 2, a linear-quadratic interpolation will be created. Similarly, linear-cubic, quadratic-cubic or bi-cubic interpolation can be created. The bi-quadratic interpolation scheme can further be constrained (using mechanical means, control means or a mixture of the two) to form a quadratic interpolation, by constraining the higher-order terms to be zero. A bi-cubic interpolation scheme can be constrained to form a cubic interpolation, by constraining the higher-order terms to be zero. In general, a vertical-horizontal interpolation scheme in which both the orders are at least k (preferably exactly k) can be constrained to form a 2D array constrained to perform a polynomial interpolation of order k, where the polynomial is a function of both the horizontal and vertical indices.

### Actuation

The 1D, 2D or 3D arrays of interpolating gears disclosed in this invention have a few degrees of freedom left in them. These degrees of freedom are exactly the number of degrees of freedom of the polynomial basis implemented. E.g. a 1D linear interpolation will have 2 degrees of freedom, a 1D quadratic interpolation will have 3, a 2D linear will have 3, a 2D bi-linear will have 4, a 2D quadratic will have 6, a 2D bi-quadratic will have 9, and so forth. These degrees of freedom are controlled by one or more actuators attached to some of the variables that the gear networks constrain. An actuator may be a manual actuator such as a handle, or it may be an electronically controlled actuator such as a motor, a servo motor, a stepper motor, etc. The motors may be attached to any of the gears being controlled, depending on how the array is to be controlled. E.g., if they are all attached to the top polynomial, the gear train will interpolate between their settings. In an embodiment, the motors are attached to the top polynomial gears, and are as equally spaced as possible. In another embodiment, motors are provided for ease of access rather than for direct interpolation and the settings of the motors so as to achieve the required polynomial is calculated using linear algebra. In an embodiment, the motors are attached to the first and/or last variables of the rows of geartrains of one or more orders. Furthermore, motors may also be attached to the lowest-k row, i.e. the row of lowest order that follows equations [Math. 10] or [Math. 11]. In the case of [Math. 10] the motor may directly control the rotation a. In the case of [Math. 11], motors may be placed to control at most two outputs, to form a linear interpolation. In one embodiment, a constant row ([Math. 10]) is controlled by controlling its rotation, whereas a single variable from one side of each higher order of rows is controlled. In another embodiment, two motors control two end points of a k=1 row, and a single variable from one side of each higher order of rows in controlled.

### Output

The output rotation of the gear train may be used directly by the application. Alternatively, the output rotation may be converted to a linear motion. This could be done using a rack (with the gears themselves acting as pinions, or by using extra pinions), or belts and pulleys, or a crank shaft arrangement. Using paths set for these linear motion elements, various non-linear functions on top of the linearly interpolated polynomial may be achieved. For some applications, this will give functions close to the required functions with a polynomial of smaller degree. Non-linear functions may also be implemented by designing appropriate mechanical linkages.

In an embodiment, more than one independent interpolating gear trains/networks are used. For example, two gear trains/networks may be used to provide two outputs at all locations (the locations that the two gear trains/networks produce the output at are point-wise close to each other). These may be used to implement an interpolated vector function.

### Applications

In an embodiment interpolating gears are used to control heliostat arrays which are both large scale and small scale. In an embodiment, flexing membranes, such as the membranes of speakers are controlled using interpolating gears. Such gears can be used in animatronics. Such gears can be used for artificial spines. Such gears can be used to control robots and robotic actuators, including for robotic surgery. Snake-like behavior can be simulated using interpolating gears. Complex airplane control surfaces can be created using interpolating gears actuating flexible or moving surfaces. The interpolating gears may control individual elements of a complex surface, or the surface may be a single unbroken elastic surface (such as a metallic surface) which flexes using the input of the gear train. A complex surface or elastic surface with settable geometry as described above may also be used for molding. A shape changing settable mold can be used to mold concrete parts, to shape curved metallic surfaces for building vehicles or architectures, for shaping sheet metal or plastic parts (e.g. using stamping, pressure molding, blow molding), etc. The present invention may be used for focusing mirrors or lenses e.g. for astronomy, cameras, etc. Many small radar or communication antennae can be focused or defocused and directions moved using interpolating gears.

### Heliostats

Heliostat arrays are (1D or 2D) arrays of mirrors which change their orientation to focus the rays of the sun onto a fixed target. In other applications, the sun may be replaced by another light source, or source of another kind of waves, and the target may be moving instead of fixed. Each mirror in the heliostat array may be flat, or it may be made into a spherical, paraboloid, cylindrical or other shape to further focus the rays as they fall onto the target.

Traditionally, each heliostat is separately controlled mechanically or electronically. In an embodiment of the present invention, a large array of heliostat mirrors is controlled together by an interpolating gear train or gear network and only as many drives as are the degrees of freedom in the gear train or gear network.

Each mirror has two degrees of angular freedom. (Mechanically there are three degrees of angular freedom to a rigid body, but rotating a mirror around an axis perpendicular to its surface going through its center will achieve close to no effect, so one degree of freedom is left out.) Each of these degrees of angular freedom is controlled by a separate interpolating gear train or network. More specifically, each of the degrees of angular freedom of a specific mirror is controlled by a particular output gear in an interpolating gear train or network. Various arrangements of how this is achieved are possible. A simple arrangement is the heliostat mirror is hinged on a ball joint. (One degree of freedom may be restricted, or the mirror may have a symmetry in one degree of freedom, so it can be kept unrestricted and will not matter.) Two vertical rods rise from the two interpolating gear trains, and meet the bottom of the mirror. As the two vertical rods move, various orientations are created.

A more complex arrangement couples the rotary impetuses directly to the two mirrors. Two rotary impetuses may be converted into two axis rotations using a mechanical arrangement. For example, a planet gear may be used. The planet gear can change both its position and its angle (based on the behavior of the sun and ring gears). Thus, this can be used to achieve position of an axis (around another axis) and turn around that axis.

Various non-linear functions may be used before the mirror actuation to get better focus over time of the day and day of the year. In an embodiment, the entire heliostat assembly is protected by a glass cover or a glass case; this prevents dust from entering the mechanical system or clouding the mirrors. In an embodiment, individual mirrors may be adjusted for perfect focus during an installation or servicing. This may be done by having extra adjustment screws or inputs. The adjustment has to be done over various possible focusing positions. This may be done practically by testing. Since the sun moves extremely slowly and will create multiple positions quite slowly, another technique such as an LED, a LASER etc may be used, and a sensor/camera at the target may be used to detect focus. This could be done at night, or during the day. If during the day, a wavelength may be used where the sun is not bright.

In an embodiment, the control of the heliostat array is entirely mathematical, based on the known position of the sun. In another embodiment, a sensor detects the focus and continuously adjusts either the control itself or the control parameters (biases) to achieve better focus. The sensor detecting the focus may be an imaging or non-imaging light sensor. Alternatively, the performance of the application itself (e.g. energy production) may be used as an indication of how good the focus is.

Applications of heliostats include using sunlight as a heat source (which may be used directly, or may be converted to electricity) or as a light source (light which may be transported for further applications e.g. using light pipes, or may be converted directly to electricity using technologies such as photovoltaic technologies). A combination of thermal and photovoltaic generation may be used to maximally convert concentrated sunlight to usable energy. Concentrated sunlight may be used to cook food, generate steam or other industrial applications of heat. Evaporation of water using concentrated sunlight can be used for multiple purposes. Apart from a heat source, a source of high pressure, and a source of electricity generation, steam can be used in multiple ways. For example, steam can be condensed again to produce high-purity water. Starting from sea water this would produce desalinated potable fresh water, as well as salt. The produced steam, esp. from seawater, can also be let off into the air to increase the humidity of air and to encourage precipitation (rainfall) in certain regions. In an embodiment, a porous tank is placed in a water body such as a sea or a lake or river, with a thermal target placed inside the porous tank. This thermal target has the ability to absorb light and heat up to a high temperature. The thermal target is placed just slightly under water. This placement may be shifted as tides change, using a float mechanism or by electromechanical control. Sunlight is concentrated onto this thermal target using heliostats. The thermal target heats up and produces large amounts of steam from the surrounding water. As this lowers the water level in the tank, the porous walls let more of the water in the water body into the tank. The pores of the porous walls are small enough to filter out most living organisms and natural detritus, to minimize impact to the machine as well as to the biosphere. This steam may be let off into the environment to increase humidity, encourage cloud formation, encourage precipitation, etc., or it may be captured to produce freshwater. Concentrated sunlight may be used to produce Hydrogen, either directly by heating water in the presence of catalysts, or through processes that convert steam to hydrogen (e.g. using iron oxide). Concentrated sunlight may be used for light applications such as illumination of architectural spaces, growing plants, growing algae, etc. Concentrated sunlight can be used to power a nuclear fusion reaction by concentrating light on a hohlraum which will convert the light to intense heat producing X-rays that heat a fusion fuel pellet which implodes producing high temperature and pressure triggering a fusion reaction.

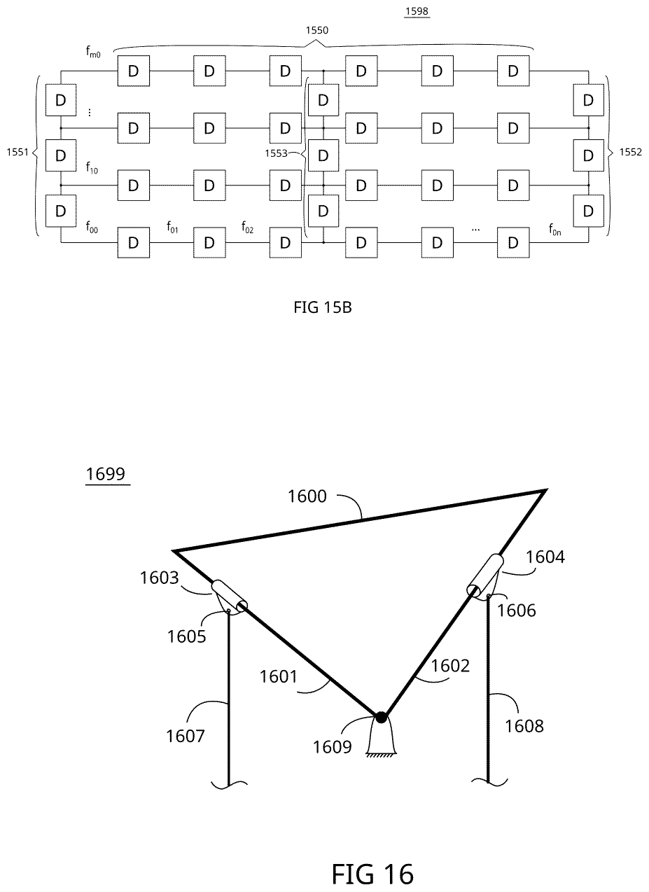

FIG. 16 depicts an element control mechanism 1699 according to an embodiment. The element being controlled may be a heliostat, or a speaker surface, or an aerodynamic element, a mold surface element, etc. A rigid frame 1600 has two arms 1601 and 1602. In an embodiment, the arms 1601 and 1602 are in the shape of straight lines. Linear slides 1603 and 1604 can slide on the two arms respectively. The linear slides 1603 and 1604 are connected through pivots 1605 and 1606 to linear control elements 1607 and 1608. Linear control elements 1607 and 1608 are controlled by two interpolating gear networks, i.e. they are the linear motion outputs of two interpolating gear networks, the outputs taken at a particular place or index in the grid of outputs. As described elsewhere, these linear outputs may be created using racks, belts/pulleys, crankshafts, etc., and may have mechanical linkages which actuate non-linear functions. The rigid frame 1600 is attached to a fixed frame using a ball joint 1609, or a spherical rolling joint, or gimbals. The element to be controlled (such as heliostat mirror, not pictured) is mounted on the rigid frame 1600. It is to be understood that even though the rigid frame 1600 is depicted as a triangle, and rigid frame having two rigid arms 1601 and 1602 is acceptable. Furthermore, the element to be controlled such as the heliostat mirror need not necessarily be in the shape of a triangle—it could be a rectangle, or circle, etc. When the interpolated functions change, the linear control elements 1607 and 1608 move, which cause the rigid frame 1600 to change its orientation, thus changing the orientation of the element to be controlled. The arms 1601 and 1602 may be curved rather than being straight, to facilitate the actuation of various transfer functions between the interpolated functions and the actual orientation created. The slides 1603 and 1604 are then not straight slides, but follow the curvature of the arms 1601 and 1602. Alternatively, the slides may have spring loaded wheels gripping the arms 1601 and 1602 to account for a varying curvature.

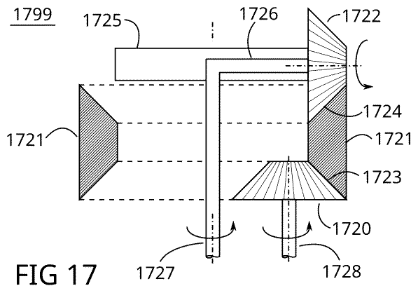

FIG. 17 depicts an element control mechanism 1799 according to an embodiment. Axle 1727 and axle 1728 are two rotating axles, that are outputs of two interpolating gear trains or gear networks. Axle 1728 is attached to and rotates bevel gear 1720. Axle 1727 is rigidly attached to bar 1726, which is set at an angle to the axle 1727, such as at a perpendicular angle. As the axle 1727 rotates, the bar 1726 rotates as well. Both the axle 1727 and the bar 1726 rotate around the central axis of axle 1727, i.e. the bar 1726 rotates around one of its ends. Bevel gear 1722 is pinned to bar 1726, and is free to rotate around the central axis of bar 1726. A ring gear 1721 is provided (depicted in two hatched parts which are two cross sections of the same single ring gear 1721). The ring gear 1721 is mechanically constrained to rotate around the central axis of axle 1727. This ring gear has two beveled surfaces, with gear teeth on each, beveled surface 1723 and beveled surface 1724. The gear teeth of the beveled surface 1723 (no gear teeth are depicted for the sake of simplicity) meshes with gear teeth of the bevel gear 1720. The gear teeth of the beveled surface 1724 mesh with gear teeth of the bevel gear 1722.

If, at a given moment, the axle 1728 is rotated whereas axle 1727 is kept fixed, the position of rod 1726 will remain fixed, but the axle 1728 will turn bevel gear 1723 which will turn ring gear 1721 which will turn bevel gear 1722. Thus bevel gear 1722 will turn around the axis of rod 1726, but this axis will not move. On the other hand, at another moment, if the axle 1727 turns, and the axle 1728 turns in such a manner that the ring gear 1721 turns by exactly the same angle as the axle 1727, then the rod 1726 will turn around the central axis of axle 1727, but the bevel gear 1722 will make no turns around rod 1726 (relative to rod 1726). Thus, by various ways of controlling the two axles 1727 and 1728, the bevel gear 1722 can be made to turn without changing the axis of the bevel gear 1722, the axis of the bevel gear 1722 can be made to change without turning the bevel gear 1722, or a combination of both a change in axis and a turn around the axis can be achieved. In this way, there is independent control on the axis around which bevel gear 1722 turns, and the amount by which bevel gear 1722 turns. A controlled surface 1725 is rigidly attached to bevel gear 1722. The controlled surface 1725 thus also turns around the central axis of the rod 1726, and the axis around which the controlled surface 1725 turns can itself be changed. Thus there are two degrees of freedom of the controlled surface 1725, controlled by the turns of axles 1727 and 1728. Controlled surface 1725 may be a heliostat mirror, and controlling these two degrees of freedom is equivalent to controlling the normal to the mirror, i.e. the orientation of the mirror. Given a direction of incoming rays (usually solar rays), and a direction in which the concentration target is present, a particular normal direction (bisecting these two directions, if the mirror is a plane mirror) will reflect the incoming rays onto the concentration target. This normal direction is set by controlling the rotation variables of axle 1727 and 1728, which may themselves be controlled by an interpolating gear train or gear network. Each mirror needs to be set to a slightly different normal direction than its neighbors, since even if the direction of incoming light is the same for all mirrors (practically true for distant light sources such as the sun), the direction of the concentration target is not the same, since the concentration target is at a finite distance. This slightly different normal direction is set for all mirrors by interpolating the directions using polynomial interpolation. Thus the directions for a large number of mirrors can be controlled using a very few electronic drives. In an embodiment, the bevel gear 1722 need not be a complete gear, but may only be half a gear stuck to the controlled surface 1725, so that the controlled surface 1725 can extend across the position of the gear. In another embodiment, the rotation of the bevel gear 1722 is further geared down using a step-down gear ratio before transferring the rotation to a mirror, which can improve positional accuracy. In an embodiment, the two interpolating gear trains or gear networks provide outputs which control respectively the axis and the rotation of the mirror surface. These outputs are connected to the axles 1727 and 1728 through one or more gears and differential gears. The output that controls the orientation of the axis is connected directly to the axle 1727, whereas the two outputs are combined using differential gears to produce the rotation of axle 1728 such that the second output specifically controls the rotation around the axis.

### Heliostat Calibration

In an embodiment, adjustment mechanics is provided to calibrate the focus of the heliostats. If linear motion outputs are utilized, screws or other adjustment methods may be provided in the linear motion elements that will change the length of the linear motion element slights. Adjustment screws of various kinds are well known in the art, including methods that use simple screws or differential screws, screws with different pitches, screws with different-handed threads, etc. Changing the setting of this adjustment method will change the length of the linear motion element, thus changing the calibration. If circular motion outputs are utilized, a fixture which introduces a settable rotation angle between two same-axis axles can be used as an adjustment mechanism. For example a sleeve that clamps two rods at a settable angle, and once clamped, maintains the angles between the rods may be used. A differential gearbox may also be used, whose two bevel gear inputs are the rotation angles before and after adjustment, and whose differential input (attached to the carrier frame) is a settable input, changing whose setting will create and maintain a permanent difference between the rotation angles of the axles before and after adjustment. These calibration methods can be applied to other applications as well, not just heliostat focus.

In an embodiment, to calibrate heliostat mirrors, a light source is provided at a certain distance. The light source may be a wide-directional point light source such as a bright LED light source, a bright arc source, etc., or it may be a narrow directional light source such as a collimated beam or laser. Heliostat mirrors are set using the interpolating gear train to concentrate the light of the light source onto the focus point (which may be same as the final focus point, or a special point chosen for the calibration). The focus point has a light detector, which may be a single light detector, a multi-pixel light detector, or a focused multi-detector light detector (the final type is usually called a camera). As the heliostat mirrors are set to focus the light onto the light detector, any mistakes in orientation of individual mirrors are detected. These are then corrected using the calibration methods above. For example, a camera may image the incoming light from each of the mirrors in a single picture. Mirrors which are out of calibration will show the light source at a wrong place, or will miss showing the light source completely. Adjusting the mirror orientation using the calibration methods (while keeping the interpolating gear train fixed) will produce a light source image exactly in the correct spot. Doing this for each mirror in turn will calibrate the heliostat array. This procedure may be completely automated by using an algorithm to detect light source images, and a feedback control algorithm to adjust the corresponding mirror. The individual mirror adjustments are applied using a screw adjustment or a rotation input to a differential gearbox using a robotic arm that can apply adjustments to individual mirror settings. This robotic arm may not be part of the heliostat mechanism, but may be a separate mechanism used only in the calibration phase. This method may be applied to multiple positions of the light source (focusing the heliostats using the interpolation mirrors only once per change of light source position), and these positions may be cycled through multiple times. In this way, various positions can all be brought into focus in the best possible manner. In an embodiment, the focusing calibration is done for a position that is, or is close to, the most central focusing position that the heliostats will encounter in the application. In an embodiment, instead of using an artificial light source for focus calibration, the sun itself is used, and the heliostats are adjusting to the position of the sun, while at the same time being calibrated.

In an embodiment, a mechanism is provided that can switch a particular adjustment sleeve from transferring the rotation of the axle forward to keeping the output rotation (towards the heliostat) fixed. This mechanism switches the mode for one mirror at a time, by choosing the row and column of the mirror. The interpolating gear train is used to bring the mirror into focus, then the mirror is switched to fixed position, then the interpolating gear train is brought into a position that ought to be the correct focusing position, and mirror is switched back to input-output clamped mode. This is done for each mirror in turn. In this way, the array may be calibrated without requiring an external robotic arm.

1. A system of interpolating gear network comprising of:
a plurality of gearboxes (198, 197, 1099, 1299, 1399) arranged sequentially in a plurality of rows (1109, 1110, 1111, 1112, 1499, 1420, 1421, 1422, 1500, 1501, 1502, 1550, 1551, 1552), wherein the plurality of rows (1109, 1110, 1111, 1112, 1420, 1421, 1422, 1500, 1501, 1502, 1550, 1551, 1552) includes a first row (497, 494, 1110, 1420) and a second row (1111, 1421), having each of the gearboxes in second row (198, 197, 1099, 1299, 1399) comprising at least a first rotary element (110, 120, 1204, 1300), a second rotary element (113, 123, 1203, 1304) and a third rotary element (111, 121, 1205, 1301), wherein the second rotary element (113, 123, 1203, 1304) is constrained to rotate by an amount equal to a linear combination of the rotations of the first rotary element (110, 120, 1204, 1300) and the third rotary element (111, 121, 1205, 1301), wherein the first rotary element (110, 120, 1204, 1300) of each of the gearboxes in second row (198, 197, 1099, 1299, 1399) except the first gearbox in second row are connected to the third rotary element (111, 121, 1205, 1301) of the preceding gearbox in second row, wherein the second rotary elements (113, 123, 1203, 1304) of the plurality of gearboxes in second row (1111, 1421) are connected to the plurality of gearboxes (198, 197, 1099, 1299, 1399) in first row (497, 494, 1110, 1420), wherein the second row (1111, 1421) of plurality of gearboxes (198, 197, 1099, 1299, 1399, 1499) produces a quadratic function and the first row (497, 494, 1110, 1420) of plurality of gearboxes (198, 197, 1099, 1299, 1399) produces a linear function.

2. The system of interpolating gear network according to claim 1, wherein the first row (497, 494, 1110, 1420) comprises sequentially arranged plurality of gearboxes (198, 197, 1099, 1299, 1399), wherein each of the plurality of gearboxes in first row (198, 197, 1099, 1299, 1399) comprises at least a first rotary element (110, 120, 1204, 1300), a second rotary element (113, 123, 1203, 1304) and a third rotary element (111, 121, 1205, 1301), wherein the second rotary element (113, 123, 1203, 1304) is constrained to rotate by an amount equal to a linear combination of the rotations of the first rotary element (110, 120, 1204, 1300) and the third rotary element (111, 121, 1205, 1301).

3. The system of interpolating gear network according to claim 2, wherein the second rotary element (113, 123, 443, 453, 503, 513, 523, 533, 543, 623, 613, 703, 804) of each of the plurality of gearboxes (198, 197, 496, 491, 599, 598, 597, 596, 595) in first row (497, 494, 492, 699, 698) are connected to the third rotary element (111, 121, 441, 451, 500, 510, 525, 530, 540, 621, 610, 700, 800) of preceding gearbox in first row if the preceding gearbox exists, and to the first rotary element (110, 120, 440, 450, 501, 511, 521, 531, 541, 620, 611, 701, 801) of succeeding gearbox in first row if the succeeding gearbox exists.

4. The system of interpolating gear network according to claim 2, wherein the first rotary element (120, 1204, 1300) of each of the gearboxes in first row (198, 197, 1099, 1299, 1399) except for the first gearbox in the first row are connected to the third rotary element (121, 1205, 1301) of preceding gearbox in first row, and wherein the second rotary elements (123, 1203, 1304) of all gearboxes in first row (198, 197, 1099, 1299, 1399) are connected to each other so as to rotate together.

5. The system of interpolating gear network according to claim 1, wherein the system further comprising one or more third rows (1112) of sequentially arranged gearboxes in third row (198, 197, 1099, 1299, 1399), wherein each of the gearboxes in third row (198, 197, 1099, 1299, 1399) comprises at least a first rotary element (120, 1204, 1300), a second rotary element (123, 1203, 1304) and a third rotary element (121, 1205, 1301), wherein the second rotary element (123, 1203, 1304) is constrained to rotate by an amount equal to a linear combination of the rotations of the first rotary element (120, 1204, 1300) and the third rotary element (121, 1205, 1301), wherein the first rotary element (120, 1204, 1300) of each of the gearboxes in third row (197, 1099, 1299, 1399, 1499) except the first gearbox in third row are connected to the third rotary element (121, 1205, 1301) of the preceding gearbox in the same third row (1112, 1422), and wherein the second rotary element (123, 1203, 1304) of a gearbox in third row is connected to rotary elements of gearboxes on a preceding row or to rotary elements of gearboxes in second row.

6. The system of interpolating gear network according to claim 1, wherein the plurality of gearboxes (198, 197, 1099, 1299, 1399) are connected in a 2D array interpolation gear network (1598, 1599) arranged in a sequence selected from linear order interpolation, bi-linear order interpolation or polynomial order interpolation.

7. The system of interpolating gear network according to claim 1, wherein the system further comprising electronic drives connected to some of the rotary elements of some of the gearboxes, the electronic drives configured to drive the system so as to create a required polynomial function.

8. The system of interpolating gear network according to claim 1, wherein the system further comprising mirrors.

9. The system of interpolating gear network according to claim 1, wherein the plurality of gearboxes (197, 1099, 1299, 1399, 1499) are planetary gears and at least two other gears.

10. The system of interpolating gear network according to claim 9, wherein the planetary gears are selected from beveled gears and face gears.
